(19) United States
(12) Patent Application Publication
(10) Pub. No.: US 2012/0072867 A1
(43) Pub. Date: Mar. 22, 2012

(54) PRESENTING POP-UP CONTROLS IN A USER INTERFACE

(75) Inventor: Eric Charles Schlegel, Redmond, WA (US)

(73) Assignee: APPLE INC., Cupertino, CA (US)

(21) Appl. No.: 12/885,375

(22) Filed: Sep. 17, 2010

(51) Int. Cl. G06F 3/048; G06F 9/54

(52) U.S. Cl. 715/808; 719/328

(57) ABSTRACT

Methods, systems, and computer-readable media for presenting pop-up controls in a user interface are disclosed. When input instructing presentation of a pop-up control within a display area of the device is received, a display object that has current input focus in the display area can be identified. A content area of the display object and a location of the display object in the display area can be determined. Then, the pop-up control can be displayed in proximity to the location of the display object while avoiding the content area of the display object. In some implementations, the pop-up control includes the menu hierarchy of an application-level menu bar.

### TECHNICAL FIELD

This disclosure relates generally to presenting pop-up controls in user interfaces for computer systems and other devices.

### BACKGROUND

Many operating systems and software applications employ graphical user interfaces (GUIs) to present information to users and to receive user input for controlling the behavior and functionalities of the underlying computing devices and/or application programs.

When interacting with an active application program through the application program's GUI, the user can sometimes cause a pop-up control, such as a contextual menu, to be presented in the GUI by providing a predetermined input (e.g., a particular keyboard combination). The contextual menu can include a small set of frequently used menu options that are applicable to the content or user interface element located at the current cursor location or the current pointer location in the GUI. The pop-up contextual menu often is anchored at the pointer location of a pointing device or a text insertion location, obscuring the content or user interface element located at the pointer location or the text insertion location.

If the user wishes to access the full menu hierarchy of the application-level menu of the active application, the user typically has to use the pointing device or keyboard navigation to move the input focus from a current input focus location to an application-level menu bar that is displayed at a designated menu location (e.g., the top of the application's active window, or the top or bottom of the desktop) on the desktop.

Sometimes, the desktop provides a desktop menu bar. The desktop menu bar is the application-level menu bar of an underlying software application that is responsible for managing the desktop GUI. The desktop menu bar can be presented at a designated location on the desktop. If a user wishes to access the menu hierarchy of the desktop menu bar, the user typically also has to shift the input focus from a current focus location to the desktop menu bar by physically moving the pointing device or by navigating element by element using the navigation keys of the keyboard.

### SUMMARY

A method for presenting pop-up controls in user interfaces is disclosed.

In one aspect, a method for presenting pop-up controls include the actions of: receiving first input instructing presentation of a pop-up control within a display area of the device; in response to the input, identifying a display object that has current input focus in the display area; determining a content area of the display object and a location of the display object in the display area; and causing the pop-up control to be displayed in proximity to the location of the display object while avoiding the content area of the display object.

In some implementations, the action of determining the content area and the location of the display object further includes: determining at least one of the content area and the location of the display object through an accessibility application programming interface (API).

In some implementations, the action of determining the content area of the display object further includes: determining a boundary of the display object; and designating an area within the boundary as the content area of the display object.

In some implementations, the action of determining the content area of the display object further includes: determining areas within the display object that contain text; and designating the areas that contain text as the content area of the display object.

In some implementations, the method further includes the actions of: prior to receiving the first input instructing presentation of the pop-up control, receiving second input selecting two or more items displayed in the display area, wherein the first input is received while the two or more items remain selected in the display area, and the action of determining the content area of the display object further includes: identifying a combination of the selected two or more items as the display object that has the current input focus; determining a combined area occupied by the selected two or more items; and designating the combined area as the content area of the display object.

In some implementations, the display object is a segment of selected text and the content area of the display object is a polygonal area enclosing the selected text.

In some implementations, the display object is a user interface element and the content area of the user interface element is a polygonal area enclosing a textual portion of the user interface element.

In some implementations, the display object is a user interface element and the content area of the user interface element is a polygonal area enclosing the user interface element.

In some implementations, the display object is a selectable object in the display area and the content area of the display object is a polygonal area enclosing the selectable object.

In some implementations, the pop-up control is a pop-up menu.

In some implementations, the pop-up menu is an application-level menu for an application window containing the display object.

In some implementations, the pop-up menu is a contextual menu that includes a partial subset of items from an application-level menu, and wherein the partial subset of items are frequently used items applicable to the display object that has the current input focus.

In some implementations, the pop-up menu contains a menu hierarchy of a first menu and a toggle option associated with an alternative menu, and selection of the toggle option causes the pop-up menu to contain a menu hierarchy of the alternative menu in place of the menu hierarchy of the first menu.

In some implementations, each of the first menu and the alternative menu is a respective one of an application-level menu and a contextual menu, wherein the contextual menu includes a partial subset of items from the application-level menu and the partial subset of items are frequently used items applicable to the display object encompassing the location of input focus.

In some implementations, the pop-up menu contains a menu hierarchy of an application-level menu associated with an active application in a desktop environment, the pop-up menu further includes an option associated with a desktop-level menu of the desktop environment, and selection of the option causes the pop-up menu to present menu items from the desktop-level menu.

In some implementations, the display area is on one of multiple displays associated with the device.

In some implementations, the display area is a region of a desktop environment that is visually enhanced through an accessibility enhancement program.

In another aspect, a method for managing pop-up menus includes the actions of: receiving an input instructing presentation of a pop-up menu in a display area; in response to the input, determining a location of input focus in the desktop environment, the location of input focus being different from a current pointer location of a pointing device in the desktop environment; and causing the pop-up menu to be presented at a location in proximity to the location of input focus in the desktop environment, wherein the menu includes a menu hierarchy of an active application-level menu bar in the desktop environment.

Some embodiments include one or more application programming interfaces (APIs) in an environment with calling program code interacting with other program code being called through the one or more interfaces. Various function calls, messages, or other types of invocations, which further may include various kinds of parameters, can be transferred via the APIs between the calling program and the code being called. In addition, an API may provide the calling program code the ability to use data types or classes defined in the API and implemented in the called program code.

At least certain embodiments include an environment with a calling software component interacting with a called software component through an API. A method for operating through an API in this environment includes transferring one or more function calls, messages, and other types of invocations or parameters via the API.

The method, systems, and apparatus disclosed herein offer one or more of the following advantages.

For example, in conventional systems, access to the menu hierarchy of the application-level menu bar requires navigation from a current input focus location or a pointer location to the application-level menu bar located at the designated menu location. When the display area of the computing device is large (e.g., when a large-sized single display device or an extended display area across multiple display devices are used), the physical motion involved in the navigation action can be substantial. When such navigation actions are frequently required during interaction with the application window, the navigation can be time-consuming and physically tedious and annoying. In addition, the user must also move his or her visual focus back and forth between an original input focus location to the application-level menu bar, and this can cause discontinuity and interruption in the workflow for the user.

By providing access to the menu hierarchy of the application-level menu bar as a pop-up menu in proximity to the current input focus location in response to a predetermined input (e.g., a single keyboard combination), the user is no longer required to navigate to the application-level menu bar by physically moving the pointer or by hopping element by element to the application-level menu bar using the keyboard's navigation keys. Therefore, the user does not have to shift his or her visual focus back and forth between the original input focus and the application-level menu bar. The likelihood of interruption to the user's workflow can be reduced.

Furthermore, if the user is visually impaired or using a visual enhancement interface, the shift back and forth between the current input focus location and the application-level menu bar at the designated menu location can be difficult for the user. For example, in a visual enhancement interface, a portion of the display area near the input focus location is magnified in a magnification window, and the visually impaired user only has a partial view of the user interface through the magnification window of the visual enhancement interface at any given time. When the designated menu location and the current input focus location cannot both fit within the magnification window of the visual enhancement interface, the user can find it challenging to move to the application-level menu bar from the current input focus location, and then return to the original input focus location.

By providing access to the menu hierarchy of the application-level menu bar in a pop-up menu in proximity to the current input focus location in response to a predetermined input (e.g., a single keyboard combination), the application menu hierarchy can be viewed from the same magnification window as the content or item under the current input focus. Therefore, the user can work with more ease. The likelihood of the user getting lost during navigation of the display area can be reduced.

In addition, when presenting the pop-up menu in proximity to the location of input focus, the operating system determines an essential content area of the display object that should be kept visible while the pop-up menu is presented. The pop-up menu presented in the user interface is not anchored exactly at the input focus location in the user interface, but is kept close to the input focus location while keeping clear of the essential content area of the display object. Thus, the user can refer to the information contained in the essential content area while working with the pop-up menu. Although examples are described with respect to pop-up menus, the methods apply to other types of pop-up controls, such as pop-up windows, pop-up control panels, pop-up keypads, and so on, as well.

The details of one or more implementations of the methods, systems, and computer-readable media are set forth in the accompanying drawings and the description below. Other features, aspects, and advantages of the methods and systems will become apparent from the description, the drawings, and the claims.

### BRIEF DESCRIPTION OF THE DRAWINGS

FIG. 1 is an exemplary user interface presenting a pop-up menu based on both the location and the content area of a display object that has the current input focus.

FIG. 2 is another exemplary user interface presenting a pop-up menu based on the location of a user-defined display object that has the current input focus and the content area of the user-defined display object.

FIG. 3 is a flow diagram of an exemplary process for presenting a pop-up control based on the location and the content area of a display object that has the current input focus.

FIG. 4 is a flow diagram of an exemplary process for determining the content area of the display object.

FIG. 5 is a flow diagram of another exemplary process for determining the content area of the display object.

FIG. 6 is a flow diagram of another exemplary process for determining the content area of the display object.

FIG. 7 is a flow diagram of an exemplary process for presenting a pop-up menu containing the menu hierarchy of active application-level menu bar based on the location of the current input focus.

FIGS. 8A-8C illustrate exemplary software architecture for implementing the menu presentation processes described in reference to FIGS. 1-7.

FIG. 9 is a block diagram of exemplary hardware architecture for implementing the user interfaces and processes described in reference to FIGS. 1-8C.

Like reference symbols in the various drawings indicate like elements.

### DETAILED DESCRIPTION

### Overview of Presenting Pop-Up Controls in User Interfaces

A computing device such as a mobile phone, personal data assistants (PDAs), personal computers or a tablet device, can include an underlying operating system and various software applications installed in the operating system to provide various application functionalities. Many operating systems and software applications employ graphical user interfaces (GUIs) to present information to users and to receive user input for controlling the behavior and functionalities of the underlying computing devices and/or application programs. A typical GUI of an operating system can be described as a “desktop” metaphor. Visually, a desktop of an operating system provides a background plane on which application windows provided by active software applications can be displayed. The desktop can also present icons and other user interface elements that represent documents, programs, or functionalities that are accessible on the device.

When a user interacts with the operating system and active application programs executing in the operating system through various user interface elements (e.g., the desktop, windows, icons, menu bars, pop-up menus, drop-down menus, buttons, text input areas, drawings canvases, object containers, scroll bars, informational fields, dialog boxes, tables, and so on) of the GUIs, input focus is passed on from element to element. Typically, only one element in the GUIs has the input focus at any time. When the user submits an input through an input device (e.g., a pointing device, a keyboard, and so on), the input is directed toward the element that has the input focus at the time the input is received.

Various types of events can cause the transition of input focus from one element to another element. For example, a system generated error message can be presented in a pop-up alert and the pop-up alert can obtain the input focus to compel the user to deal with the error message promptly. In some cases, an event that causes the transition of input focus from one element to another element can be a hover and selection action by a pointing device. In some cases, an event that causes the transition of input focus from one element to another element can be a navigation action by a keyboard. Other events that can cause the input focus to shift from element to element are possible.

Because the input focus can be changed from one element to the next through various means or due to various types of events, the element that has the current input focus is not necessarily always located at the current pointer location of a pointing device. In addition, when multiple items are selected, the multiple selected items as a whole has the input focus, even though the multiple items may be located at different coordinate locations on the user interface. As a result, neither the pointer location nor the text cursor location necessarily reflects the location of the display object (e.g., the combination of the selected items) that has the current input focus.

Sometimes, when a user wishes to interact with the application-level menu bar of an application program while working within the active window of the application program, the user can move the pointer (e.g., an arrow shaped position indicator) of a pointing device to the application-level menu bar or enter a series of navigation inputs via the keyboard's navigation keys (e.g., the tab key or arrow keys) to hop element by element from a current focus location to the application-level menu bar. However, such navigation actions can be difficult and tedious when the display area is large, or when the display area is viewed through a magnification interface of an accessibility enhancement program.

In some implementations, as disclosed herein, the menu hierarchy of the application-level menu bar for a current active window can be made accessible as a pop-up menu presented near the current input focus location in response to a predetermined user input. As a result, the user no longer has to go through the physical navigation back and forth between the current input focus location and the designated menu location on the desktop over a large distance to get access to the menu hierarchy of the application-level menu bar. The user may still need to navigate between the displayed pop-up menu and the current input focus location over a small distance, but the physical movement and the likelihood of causing discontinuity in the workflow can be significantly reduced.

In some implementations, as disclosed herein, the exact location for displaying the pop-up menu can be determined based on both the location of a display object that has the current input focus location and the boundary of a content area for the display object. Depending on the immediate prior user actions and the current state of items in the display area, the display object that has the current input focus can be defined differently.

For example, when the input focus is at a text insertion point in a text input area (e.g., an editable document displayed in a word processing window), the display object that has the input focus can be defined as a block of text that encompass the text insertion point. For another example, when the input focus is on a user interface element in the display area, the display object can be defined as the user interface element.

Other ways of defining a display object that has the current input focus are possible. The definition of the display object that has the current input focus can depend the nature and type of one or more items in the display area that are at or near the location of input focus (e.g., the text insertion point) or the user interface element (e.g., a selected icon) that has the input focus in the display area. More details on the definition of the display object are provided later in the specification.

Usually, a display object that has the current input focus can occupy an area that includes some essential information content that the user wishes to keep visible when providing input directed toward the display object. The areas of the display object that contains the essential information can be designated as the content area of the display object. Typically, the display object can also have some areas that contain non-essential information content or no information content. The content area of a display object can vary depending on the nature and type of display object that has been defined. In some implementations, the content area of a display object can also vary depending on the user's individual levels of familiarity with the user interface element(s) included the display object.

In some cases, the operating system already has access to the information on the location of the current input focus and the user interface element(s) that have the input focus in the display area. For example, when the desktop has the current input focus, the location of the user input focus is known to the operating system as coordinates on the desktop. If the location of the input is on a particular user interface element or a combination of multiple items on the desktop, the operating system can already have the necessary information to determine the locations, types, and content of the user interface element(s) and items that are used to define the display object having the current input focus. The operating system can also use such information to determine the content area of the display object.

For application programs that are not integrated into the operating system, information on the exact locations, types, and content of the user interface elements and/or items that have the current input focus is not necessarily available to the operating system directly. The operating system can obtain the information from the active program indirectly via some other communication interfaces. Examples of such communication interfaces include, for example, an accessibility application programming interface (API) or a text services API. Other interfaces for requesting and obtaining input focus information from the active programs are possible. For example, a text services API can sometimes be used to obtain information of the location and content of text in a text-editing interface. The information obtained through the text services interface can be used to define display object formed of text near the location of input focus, and to determine the content area of the display object.

When the operating system receives the input instructing the presentation of a pop-up control (e.g., the pop-up menu including the contextual menu hierarchy or the application menu hierarchy) near the current focus location, the operating system can decide where exactly to present the pop-up control. Once the operating system has determined the location of input focus, defined the display object that has the input focus, and determined the content area of the display object that has the input focus, the operating system can select a location that is closest to the input focus location, but at the same time avoid the obscuration of the content area of the display object. For example, the corner anchor of the pop-up control can be adjusted to be as close to the location of input focus as possible, while keeping the pop-up control clear of the content area of the display object that has the current input focus.

In some implementations, other factors (e.g., the total size of the display area) can also be taken into account when deciding the presentation location of the pop-up control. After a suitable location for the pop-up control is determined, the operating system can present the pop-up control at that location. The user can start interacting with the pop-up control in a usual manner.

### Exemplary User Interfaces Presenting Pop-up Controls

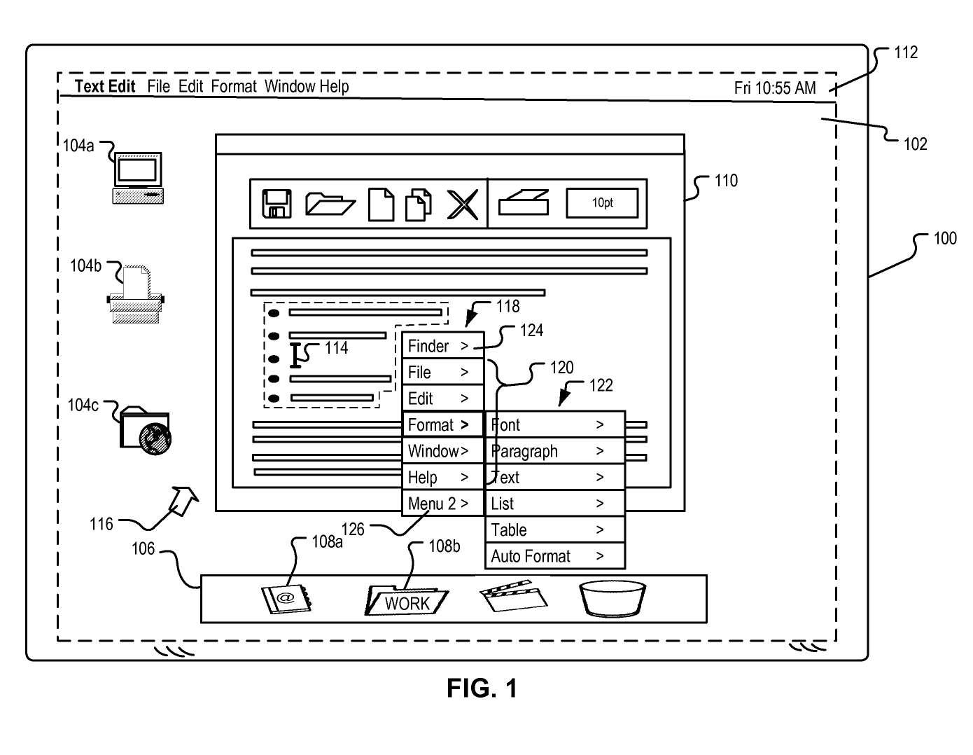

FIG. 1 is an exemplary user interface presenting a pop-up menu at a location determined based on the location and the content area of a display object that has the input focus.

In the example user interface shown in FIG. 1, a desktop 102 (or a portion thereof) is displayed on a display area 100 of a display device. The display device can be one or multiple display devices associated with a computing device. The display area 102 can also be a portion of a larger display area (e.g., an extended display area) that is not completely shown.

The desktop 102 can include user interface elements such as desktop icons 104a-c representing devices, applications, folders, and/or files. The desktop 102 can also include user interface elements, such as a docking station 106 for frequently used applications and documents. The docking station 106 can include user interface elements 108a-b representing the applications and documents. Other user interface elements can be presented on the desktop 102.

The desktop 102 can also present an active application window 110. The active application window 110 can be provided by an active application program executing in the operating system. In this example, the application window 110 is provided by a word processing application. The application-level menu bar 112 can be presented at a designated menu location at the top of the desktop 102. In some implementations, the application-level menu bar can also be presented at the top of the active window 110. If the input focus is changed to a different application or the desktop, the application-level menu bar of the different application or the desktop menu bar can be presented at the designated menu location on the desktop 102 in place of the application menu bar 112. In some implementations, a desktop menu bar (not shown) can be presented along with the application-level menu bar on the desktop.

In this example, the user has typed some text in a text input area of a document open in the application window 110. The text that has already been entered includes some paragraphs, and a list in the mist of the paragraphs. The user has moved the text insertion point to the middle of the list, preparing to enter additional items to the list at the text insertion point. The text insertion point can be indicated by a blinking text cursor 114.

The user can move the text insertion point within the document using a keyboard or a pointer of a pointing device. Other input devices, such as a touch-sensitive surface, a joystick, a scrolling device, a motion-sensitive input device, and so on, can also be used to move the text insertion point within the document. Regardless of how the text insertion point is moved, when the text insertion point is placed at the desired location in the document, the user can move the pointer of the pointing device to a different location without affecting the location of the text insertion point. As shown in FIG. 1, the location of the pointer 116 of the pointing device can be located apart from the text insertion point under the blinking text cursor 114.

The text insertion location as indicated by the blinking text cursor 114 can be located within the document in an area between two adjacent words, at the end of a word, or between two empty spaces. In the example shown in FIG. 1, the text insertion point is located in the middle of the list between two adjacent list items. If the user starts typing, the newly entered text would be inserted at the text insertion point. The location of the text insertion point is the location of input focus, and the text input area at the text cursor 114 has the input focus.

As illustrated in FIG. 1, when the user enters a predetermined input instruction the presentation of a pop-up menu, for example, through a particular keyboard combination, a pop-up menu 118 can be presented at or near the current input focus location. The current input focus location in this case is the location of the text cursor 114. The top-level options of the pop-up menu 118 can include the top-level menu options of the application menu hierarchy associated with the active application-level menu bar 112, shown as items 120. The user can navigate within the application menu hierarchy in a usual manner, such as by using the arrow keys of the keyboard or the pointing device. For example, if the user has selected the item “Format” from the menu options 120, a sub-level of the application menu hierarchy under the selected menu option can be presented as a submenu 122. When the user has completed the selection, the selected option is applied to the space at the text insertion location, and text subsequently entered at the text insertion location would be affected by the selection option.

In some implementations, in addition to the top-level menu options of the application-level menu bar, the pop-up menu 118 can also include a menu option to open the desktop menu hierarchy. For example, as shown in FIG. 1, the menu option 124, when selected, can cause the top-level menu options of the desktop menu hierarchy to be presented as a submenu of the pop-up menu 118. The menu option 124 in the pop-up menu 118 can allow the user to get access to the desktop menu hierarchy without requiring the user to shift the input focus to the desktop or navigating to the desktop menu bar presented at the designated menu location of the desktop after the input focus is shifted to the desktop.

In some implementations, as shown in FIG. 1, the pop-up menu 118 can also include a menu option 126. The menu option 126 can cause a contextual submenu that includes a subset of frequently accessed menu options from the application menu hierarchy. For example, when the input focus location is in the middle of text, the options relevant to text editing, such as formatting related options, copy and paste, spell checking, dictionary, and so on, can be presented in the contextual menu. For another example, if the input focus location is inside a table in the document, table related options, such as adding rows and columns, table formatting options, sorting options, and so on can be presented in the contextual submenu.

In some implementations, the menu option 126 can be a toggle control. For example, when the application-level menu hierarchy is presented in the pop-up menu 118 initially, when the user selects the toggle control 126, the pop-up menu can display the contextual menu hierarchy instead. For example, the top-level options 120 can be replaced with the top-level options of the contextual menu hierarchy when the toggle option 126 is selected. While the contextual menu hierarchy is presented in the pop-up menu 118, if the user selects the toggle control 126 again, the application-level menu hierarchy can be presented in the pop-up menu replacing the contextual menu hierarchy. For example, the top-level options 120 can be returned to the pop-up menu 118.

In some implementations, the pop-up menu 118 presents the top-level options from the application-level menu hierarchy by default, in response to the predetermined input instructing the presentation of the pop-up menu. In some implementations, the pop-up menu 118 presents the top-level options from the contextual menu hierarchy by default, in response to the predetermined input instruction the presentation of the pop-up menu.

The pop-up menu that provides access to both the contextual menu hierarchy and the application menu hierarchy offers the convenience of the contextual menu, and the completeness of the application-level menu hierarchy. At the same time, because the pop-up menu is presented near the location of current input focus through a predetermined input (e.g., a predetermined keyboard combination), the user is not required to navigate back and forth between the main application menu bar and the current input focus location using the pointing device or the usual keyboard navigation hopping element by element in a sequence.

As illustrated in this example, the application menu hierarchy is presented near the current location of input focus without the user having to move the input focus to the designated menu location at the top of the desktop (or to the designated menu location at the top of the application window).

If an accessibility enhancement program is currently active, the magnification window of the accessibility enhancement program can display a portion of the application window 110 that includes the current focus location. When the pop-up menu 118 is displayed near the location of input focus in response to the predetermined input without involving the movement of the pointer or keyboard navigation to the location of the application-level menu bar 112, the view port of the magnification window does not need to be moved away from the current input focus location to the location of the application-level menu bar 112. Instead, the menu hierarchy of the application-level menu bar is made accessible through the pop-up menu displayed near the current location of input focus within the magnification window.

Similarly, if an extended desktop that extends across multiple display devices is used and the active application window is presented on a different display device than the primary display device, the application-level menu bar 112 of the active application window 110 would be presented on the primary display device far apart from the application window 110. When the user enters the predetermined input instruction the presentation of the pop-up menu, the menu hierarchy of the application-level menu bar can be presented on the display device showing the active window, without requiring the user to move the location of input focus to the application-level menu bar at the designated menu location on the primary display device.

In some implementations, the pop-up menu 118 can be presented at a location that is close to the current input focus location (e.g., as indicated by the text cursor 114). However, instead of having the pop-up menu anchored at exactly the location of input focus, the operating system can identify a display object encompassing the location of input focus and the display object is deemed to have the current input focus. Then, the operating system can determine a content area of the display object that should not be obscured by the pop-up menu 118.

For example, as shown in FIG. 1, the current focus location is in the middle of two list items in a list. In some implementations, the entire list can be defined as the display object having the input focus. The reason for having the entire list as the display object is that the user may wish to have the entire list visible while modifying or inserting additional items into the list. In some implementations, if the text insertion location is in the middle of a block of text, such as a word, a sentence, a paragraph, and so on, the block of text can be identified as the display object encompassing the location of input focus, i.e., the display object that has the input focus under the current context.

In some implementations, the content area of the display object can be a smallest rectangular area that encloses the list or the block of text. In some implementations, the content area of the display object can have any shape depending on the pixels occupied by the list or the block of text. For example, the boundary of the content area can trace the overall outline of the pixels of the characters of the block of text at a predetermined distance (e.g., a few pixels) away from the pixels of the text. The content area can be a polygonal area defined by the boundary tracing the pixels of the block of text. The operation system can specify the maximum number of edges for the polygonal area enclosing the pixels of the block of text. The larger the number of edges, the more closely the boundary of the content area traces the overall outline of the pixels of the block of text.

As shown in FIG. 1, the text cursor 114 is located between two items in a list, the block of text include all list items. The boundary of the content area is indicated by the dashed line. Instead of anchoring the pop-up menu 118 at the location of the text cursor 114, the pop-up menu 118 is anchored at a location close to the text cursor 114, but kept clear of the content area occupied by the list items.

Although a word processing interface is used in the above example, the presentation of pop-up menus as described above can be applicable to other user interfaces as well. For example, if the input focus is on an icon located on the desktop 102, when the user enters the predetermined input, the icon can be identified as the display object and the content area of the icon can be determined to include both the graphical portion and the text portion of the icon, only the graphical portion of the icon, or only the text portion of the icon. Once the content area of the icon is determined, the desktop menu hierarchy can be presented in a pop-up menu near the icon while staying clear of the content area of the icon.

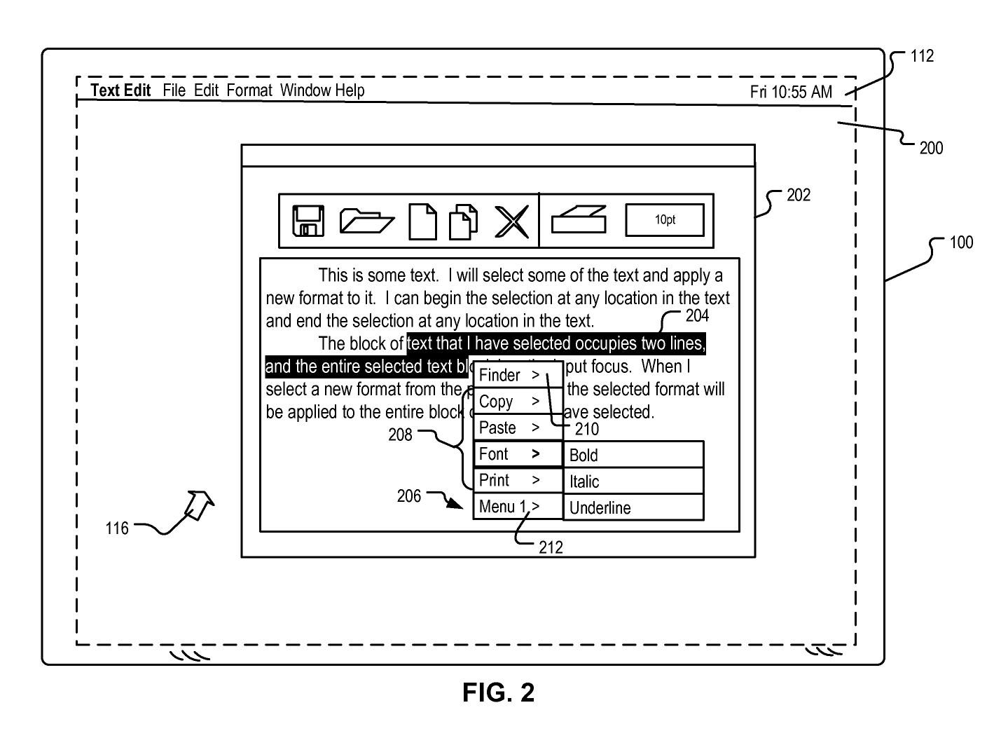

FIG. 2 is an example user interface 200 illustrating the presentation of a pop-up menu near a user-defined display object, where the input focus applies to the entire user-defined display object. The user-defined display object can be a highlighted block of text, a set of selected icons, multiple simultaneously selected graphical objects in an application window, or other formations that are defined ad hoc by the user. Since the shape and extent of the user-defined display object is not predetermined, the operating system can determine the nature and boundary of the user-defined display object after the user has defined the display object (e.g., by selecting/highlighting the constituent items forming the display object) and entered the predetermined input instructing presentation of the pop-up menu.

For example, as shown in FIG. 2, the user has highlighted a block of text 204 in the application window 202. The user can highlight the block of text 204 in various manners enabled by the operating system and the application. For example, the user can highlight the block of text by double clicking on a word or paragraph, or swipe across the block of text on a touch-sensitive surface, or select the text using the keyboard. After the block of text is selected (e.g., appears highlighted), the input focus is on the entire block of the selected text. The pointer of the pointing device can still move freely, but that movement of the pointer does not shift the focus location away from the highlighted text. The text cursor also disappears from the user interface 202.

When the user enters the predetermined input instructing the presentation of the pop-up menu (e.g., the application-level menu or the contextual menu), the operating system can identify the items or text that are selected or highlighted by the user and designate the selected items or text as a whole as the display object that has the current input focus. The location of the display object can be the location of the selected block of text (e.g., as represented by the center or a corner of the block of text). In order to determine the content area of the display object, the operating system can determine a boundary that encloses all the content that should not be obscured by the pop-up menu.

In this example, a polygon (e.g., a rectangle or an octagon) with a given number edges can be used to enclose the significant content in the display object. As shown in FIG. 2, the highlighted block of text 204 occupies two lines in the text input area and can be enclosed by a polygon having eight edges. The area enclosed by the polygon can be designated as the content area of the display object (e.g., the block of selected text 204).

Once the operating system has determined the location and the content area of the user-defined display object (e.g., the selected block of text), the operating system can present the pop-up menu 206 near the location of the user-defined display object, while keeping the pop-up menu 206 clear of the content area of the user-defined display object.

As shown in FIG. 2, the pop-up menu 206 can include the top-level options 208 of a contextual menu hierarchy, a menu option 210 leading to the desktop menu hierarchy, and/or a toggle option 212 leading to the presentation of the application menu hierarchy in place of the contextual menu hierarchy in the pop-up menu 206.

Although selected text is used as an example of user-defined display objects. The determination of location and content area illustrated in this example can apply to other kinds of user-defined display objects. For example, if the user-defined display object is a collection of icons that are simultaneously selected items (e.g., icons, graphical objects, etc.) in the user interface, the location of the user-defined object can be the center of the selected items or one of the selected items. The content area of the user-defined object can be a single polygonal area enclosing all of the selected items. For example, the polygon enclosing the selected items can be a mathematical convex hull of the selected items. Alternatively, if the selected items are spaced far apart, the content area of the user-defined display object can be two or more disjoint polygonal areas, each enclosing one or more of the selected items.

The above user interfaces are merely illustrative. Other user interfaces, and scenarios for presenting pop-up controls (e.g., pop-up menus, pop-up control panels, etc.) near a location of input focus while keeping the essential content area of a display object encompassing the location of input focus visible in the user interface.

Although only text related examples are shown in the above examples, other types of user interface elements, geometrical shapes, selectable objects, graphical objects, and so on can be used as items that form the display objects. Even though clearly defined text objects such as a list is used in the example shown in FIG. 1, other forms of defining a block of text constituting a display object can be used.

In some implementations, if the text insertion point is in the middle or at either end of a consecutive sequence of symbols, the display object can be defined as the entire consecutive sequence of symbols. The consecutive sequence of symbols can be delimited by some special symbols, such as white spaces, certain types of punctuation marks, line breaks, and so on. Alternatively, the sequence of symbols can be defined semantically, such as characters of an alphabet that form a word or a phrase. In some implementations, if the text insertion point is in between two adjacent white spaces, the display object can be defined as the block of text that is within a small, predetermined number of spaces away from the text insertion point.

In some implementations, when a user clicks on a title bar of an open window, selects an icon on the desktop, or selects a selectable graphical object in an application window, the selected item (e.g., the title bar, the icon, the graphical object, or other currently selected user interface elements in the display area) obtains the current input focus, and the user's next input would be directed toward and applied to the selected item by the operating system. At this point, the display object can be defined as the selected item that has the current input focus.

In some implementations, sometimes when the user selects a block of text of arbitrary length that begins and ends at arbitrary locations in the document, the entire block of selected text has the input focus, rather than any particular locations within the block of text. After the selection, the indicator of the pointing device can be moved away from the selected block of text without shifting the input focus away from the selected block of text. The text insertion location can also disappear from the display area. The display object that has the current input focus can thus be defined as the entire block of selected text.

In some implementations, when the user selects multiple items in the display area simultaneously, the multiple selected items have the input focus as a unit. For example, the user can select multiple icons on the desktop simultaneously, and drag the multiple selected icons as a unit to a different location on the desktop. Although the individual selected items may occupy different areas on the desktop, the multiple selected items as a whole can be defined as the display object that has the current input focus.

Although specific text-based examples are given to describe how the content area of a display object can be defined. Other methods of determining the content area are possible.

For example, a display object can occupy an area that includes empty space, a background image, information content, and/or one or more active controls. The empty space and the background image not showing any information content or the active controls can be excluded from the content area defined for the display object. Depending on the familiarity of the user with the user interface elements included in the display object, the area occupied by some of the information content can also be excluded from the content area defined for the display object. For a more specific example, if the display object is a pop-up ad, and the user has indicated in a preference setting that he only wishes to see the title of the ad and the controls for closing the pop-up ad. Then, the content area of the pop-up ad can be defined to be the areas occupied by the title bar and the control for closing the pop-up ad.

For another example, a block of selected text can occupy a background area on which text is overlaid. Part of the background area not overlaid with text can be obscured without interfering with a user's ability to recognize the text, particularly when large font sizes are used for the text. Therefore, if the block of selected text is defined as the display object that has the current input focus, the content area of the display object can be defined to be a polygonal area whose edges trace around the outline of the text. In some implementations, the operating system can specify the maximum number of edges for the polygonal area to enclose the entire block of selected text. By specifying a larger maximum number of edges for the polygonal area, the content area of the display object can be reduced to match the outline of the text more closely.

For another example, if the display object that has the current input focus is defined to be a currently selected user interface element and the selected user interface element includes a graphical component and a textual component. The content area of the selected user interface element can be defined to include only the areas occupied by the textual component. For example, if the display object is a selected document icon, the content area of the display object can be area occupied by the text label of the selected icon.

For another example, if the display object that has the current input focus is a combination of multiple simultaneously items, the content area of the display object can be a single continuous area that encompasses all of the selected items. Alternatively, the content area of the display object can also be defined to be the combination of several disjoint areas, each of the disjoint area enclosing one or more of the selected items and the disjoint areas together encompassing all of the selected items.

Other definitions of the content areas are possible.

As disclosed herein, the operating system, rather than the active application is responsible for presenting the pop-up controls in the user interface in response to the predetermined user input instructing such presentation.

In some cases, the operating system already has access to the information on the location of the current input focus and the user interface element(s) that have the input focus in the display area. For example, when the desktop has the current input focus, the location of the user input focus is known to the operating system as coordinates on the desktop. If the location of the input is on a particular user interface element or a combination of multiple items on the desktop (e.g., one or more icon on the desktop, a folder window, an application window, or other user interface elements related to operating system functions), the operating system can already have the necessary information to determine the locations, types, and content of the user interface element(s) and items that are used to define the display object having the current input focus. The operating system can use such information to determine the content area of the display object.

If the input focus is on items and/or user interface elements within an active application window, the operating system can obtain the information on the location, type, and content of the items and user interface elements that have the input focus. For programs that are integrated into the operating system, the operating system can obtain the information on the location, type, and content of the user interface elements and items through various internal function calls.

For application programs that are not integrated into the operating system, information on the exact locations, types, and content of the user interface elements and/or items that have the current input focus is not necessarily available to the operating system directly. The operating system can obtain the information from the active program indirectly via some other communication interfaces.

In some implementations, the operating system can provide an accessibility API that facilitate the communication of information between an active application program and an accessibility enhancement program of the operating system. The accessibility program can use the information provided through the accessibility API to provide various enhancements to the visual appearance of the content and user interface elements in the application program's active window. The visual enhancements can be presented in a magnification window, for example.

Through the accessibility API of the operating system, the applications supporting the accessibility enhancement can provide information on the coordinate location of the user input focus as well as the number, type, content of items that are currently selected and/or visible in the application window. In addition, when requested by the operating system through the accessibility API, the application program can also provide the size of the items or textual content (e.g., in terms of character length or pixel information) to the operating system through the accessibility API.

In some implementations, instead of or in addition to an accessibility API, the operating system can also obtain location of a text insertion point and the words, phrases, sentences, paragraphs that are located near the text insertion point in an application window through a text services API. The text services API for example, can recognize a block of text, e.g., paragraphs, sentences, words, phrases, in a text-editing window, and provide that information to the operating system. The operating system can then use the information to determine the content area of the block of text.

### Exemplary Processes for Presenting Pop-Up Controls in User Interfaces

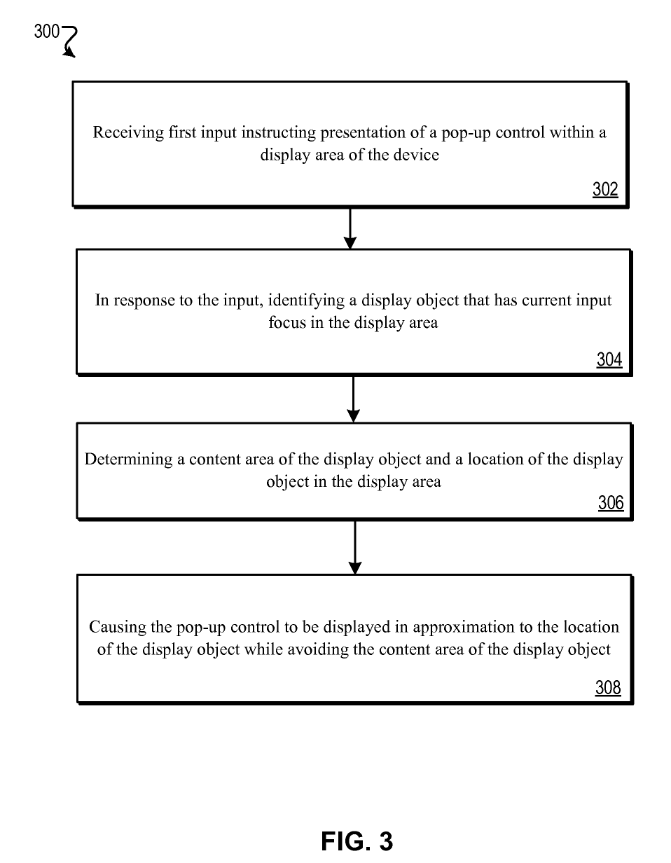

FIGS. 3-7 are exemplary processes for presenting pop-up controls in the manner as described above. FIG. 3 is a flow diagram of an exemplary process 300 for presenting a pop-up control at a location based on the location and the content area of a display object that has the input focus. In the process 300, first input instructing presentation of a pop-up control within a display area of the device can be received (302). In response to the input, a display object that has current input focus in the display area can be identified (304). Then, a content area of the display object and a location of the display object in the display area can be determined (306). Then, the operating system can cause the pop-up control to be displayed in proximity to the location of the display object while avoiding the content area of the display object (308). As described above, at least one of the content area and location of the display object can be determined through an accessibility API.

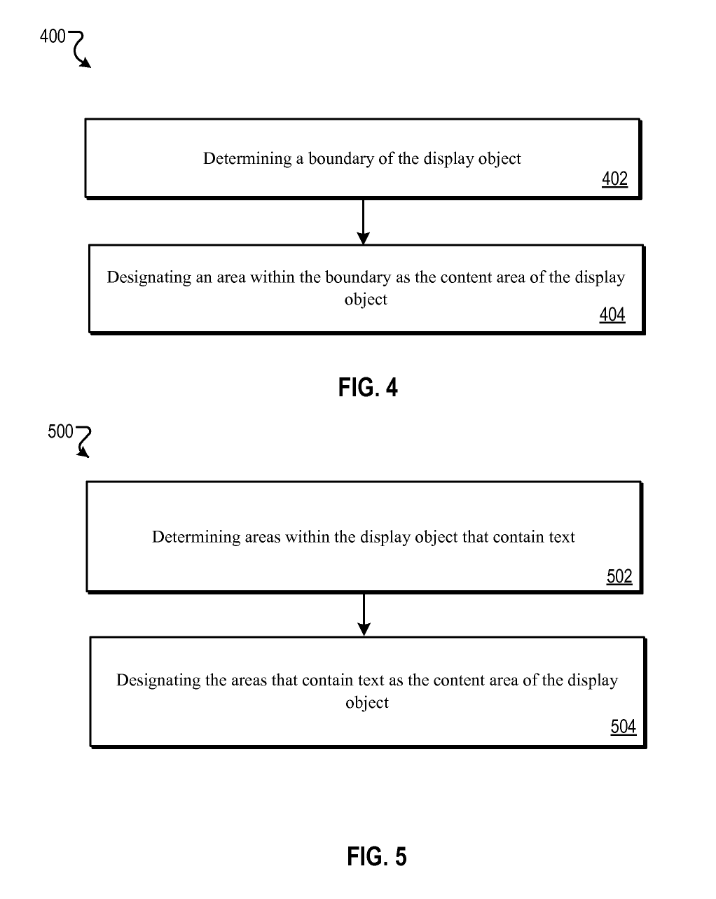

FIG. 4 is an exemplary process 400 for determining the content area of the display object. In the exemplary process 400, first a boundary of the display object can be determined (402). Then, an area within the boundary can be designated as the content area of the display object (404).

FIG. 5 is another exemplary process 500 for determining the content area of the display object. In the exemplary process 500, first, areas within the display object that contain text can be determined (502). Then, the areas that contain text can be designated as the content area of the display object (504).

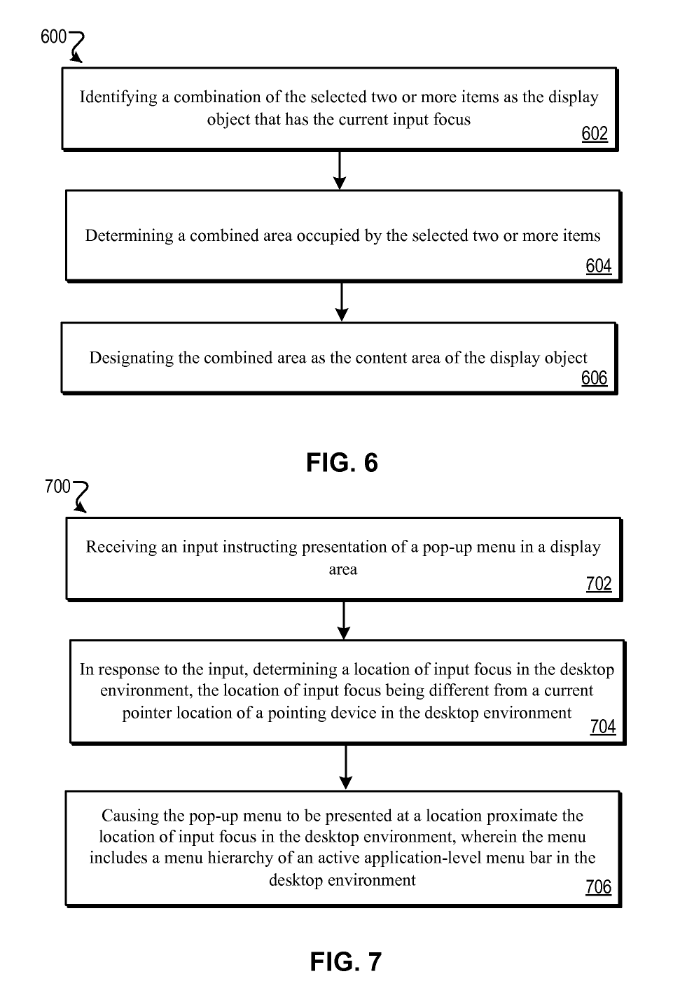

FIG. 6 is another exemplary process 600 for determining the content area of the display object. Prior to receiving the first input instructing presentation of the pop-up control, second input selecting two or more items displayed in the display area can be received, where the first input is received while the two or more items remain selected in the display area. In the example process 600, a combination of the selected two or more items can be identified as the display object that has the current input focus (602). A combined area occupied by the selected two or more items can be determined (604). Then, the combined area can be designated as the content area of the display object (606).

There can be various kinds of display objects. In some implementations, the display object is a segment of selected text, and the content area of the display object is a polygonal area enclosing the selected text. In some implementations, the display object is a user interface element, and the content area of the user interface element is a polygonal area enclosing a textual portion of the user interface element. In some implementations, the display object is a user interface element, and the content area of the user interface element is a polygonal area enclosing the user interface element. In some implementations, the display object is a selectable object in the display area, and the content area of the display object is a polygonal area enclosing the selectable object.

In some implementations, the pop-up control is a pop-up menu. In some implementations, the pop-up menu can be an application-level menu for an application window containing the display object. In some implementations, the pop-up menu can be a contextual menu that includes a partial subset of items from an application-level menu, where the partial subset of items are frequently used items applicable to the display object that has the current input focus. In some implementations, the pop-up menu contains a menu hierarchy of a first menu and a toggle option associated with an alternative menu, and selection of the toggle option causes the pop-up menu to contain a menu hierarchy of the alternative menu in place of the menu hierarchy of the first menu. In some implementations, each of the first menu and the alternative menu is a respective one of an application-level menu and a contextual menu, where the contextual menu includes a partial subset of items from the application-level menu and the partial subset of items are frequently used items applicable to the display object encompassing the location of input focus.

In some implementations, the pop-up menu contains a menu hierarchy of an application-level menu associated with an active application in a desktop environment. The pop-up menu can further include an option associated with a desktop-level menu of the desktop environment, and selection of the option causes the pop-up menu to present menu items from the desktop-level menu.

In some implementations, the display area can be on one of multiple displays associated with the device. In some implementations, the display area can be a region of a desktop environment that is visually enhanced through an accessibility enhancement program.

FIG. 7 is a flow diagram of an exemplary process 700 for presenting an application-level menu bar near the location of input focus. In the process 700, an input instructing presentation of a pop-up menu in a display area can be received (702). In response to the input, a location of input focus in the desktop environment can be determined, where the location of input focus is different from a current pointer location of a pointing device in the desktop environment (704). Then, the operating system can cause the pop-up menu to be presented at a location in proximity to the location of input focus in the desktop environment, where the pop-up menu includes a menu hierarchy of an active application-level menu bar in the desktop environment (706).

Other processes used in presenting pop-up controls in the manner described in this specification can be apparent in light of the descriptions in this specification.

### Exemplary Software Architecture

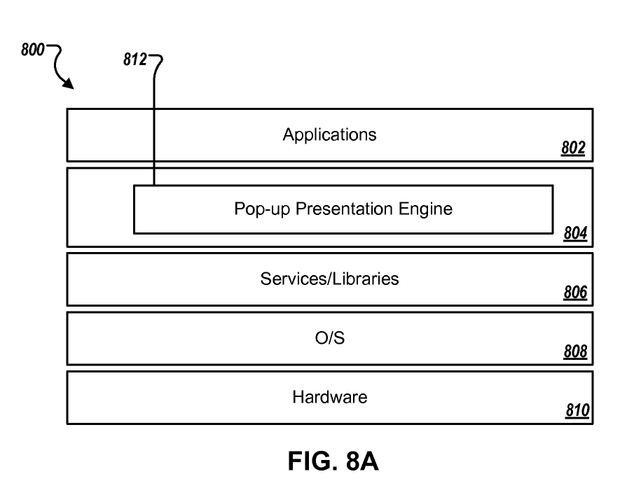

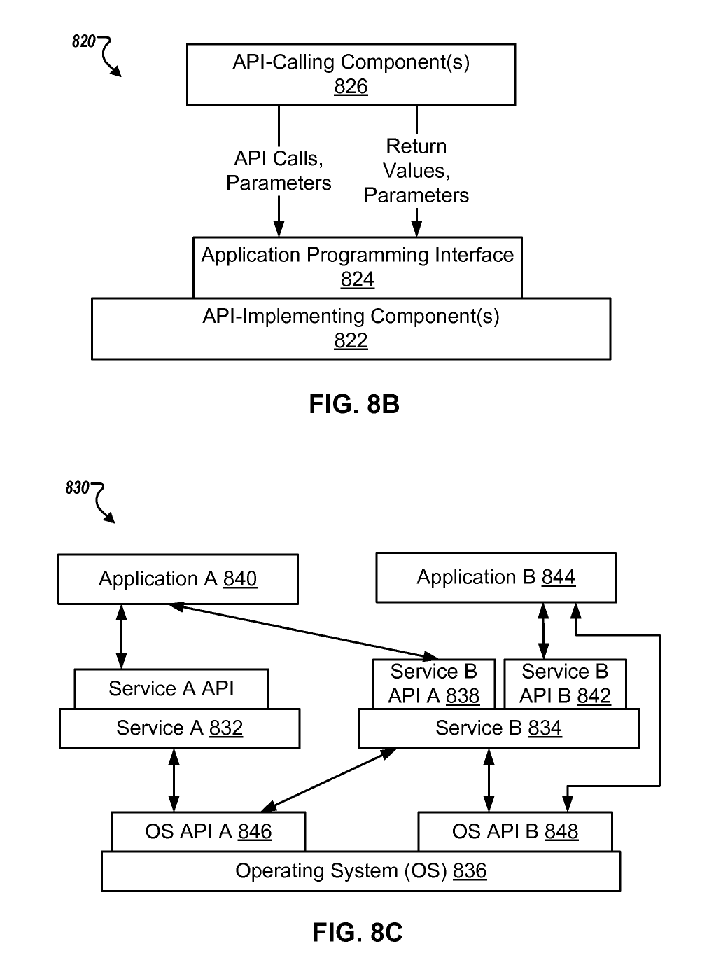

FIG. 8A is an exemplary software architecture for implementing the processes and user interfaces described in reference to FIGS. 1-7. In some implementations, the program modules implementing the processes can be part of a framework in a software architecture or stack. An exemplary software stack 800 can include an applications layer 802, framework layer 804, services layer 806, OS layer 808 and hardware layer 810. Applications (e.g., email, word processing, text messaging, etc.) can incorporate function hooks to an accessibility API. Framework layer 804 can include pop-up menu presentation engine 812. The pop-up menu presentation engine 812 can make API calls to graphics services or libraries in services layer 806 or OS layer 808 to perform all or some of its tasks described in reference to FIGS. 1-7. The pop-up menu presentation engine 812 can also make API calls to the application layer 802 to obtain the information necessary to define the display object, and determine the location and the content area of the display object according to the descriptions disclosed in this specification. The pop-up menu presentation engine 812 can also make API calls to services or libraries (e.g., text services) in services layer 806 or OS layer 808 to perform all or some of its tasks.

Services layer 806 can provide various graphics, animations and UI services to support the graphical functions of the pop-up menu presentation engine 812 and applications (e.g., the word processing application) in applications layer 802. In some implementations, services layer 806 can also include a touch model for interpreting and mapping raw touch data from a touch sensitive device to touch events (e.g., gestures, rotations), which can be accessed by applications using call conventions defined in a touch model API. Services layer 806 can also include communications software stacks for wireless communications.

OS layer 808 can be a complete operating system (e.g., MAC OS) or a kernel (e.g., UNIX kernel). Hardware layer 810 includes hardware necessary to perform the tasks described in reference to FIGS. 1-7, including but not limited to: processors or processing cores (including application and communication baseband processors), dedicated signal/image processors, ASICs, graphics processors (e.g., GNUs), memory and storage devices, communication ports and devices, peripherals, etc.

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments, the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments, the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments, an application or other client program may use an API provided by an Application Framework. In these embodiments, the application or client program may incorporate calls to functions or methods provided by the SDK and provided by the API, or use data types or objects defined in the SDK and provided by the API. An Application Framework may, in these embodiments, provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however, the API may be implemented in terms of a specific programming language. An API-calling component can, in one embodiment, call APIs from different providers such as a set of APIs from an OS provider and another set of APIs from a plug-in provider and another set of APIs from another provider (e.g. the provider of a software library) or creator of the another set of APIs.

FIG. 8B is a block diagram illustrating an exemplary API architecture, which may be used in some embodiments of the invention. As shown in FIG. 8B, the API architecture 820 includes the API-implementing component 822 (e.g., an operating system, a library, a device driver, an API, an application program, software or other module) that implements the API 824. The API 824 specifies one or more functions, methods, classes, objects, protocols, data structures, formats and/or other features of the API-implementing component that may be used by the API-calling component 826. The API 824 can specify at least one calling convention that specifies how a function in the API-implementing component receives parameters from the API-calling component and how the function returns a result to the API-calling component. The API-calling component 826 (e.g., an operating system, a library, a device driver, an API, an application program, software or other module), makes API calls through the API 824 to access and use the features of the API-implementing component 822 that are specified by the API 824. The API-implementing component 822 may return a value through the API 824 to the API-calling component 826 in response to an API call.

It will be appreciated that the API-implementing component 822 may include additional functions, methods, classes, data structures, and/or other features that are not specified through the API 824 and are not available to the API-calling component 826. It should be understood that the API-calling component 826 may be on the same system as the API-implementing component 822 or may be located remotely and accesses the API-implementing component 822 using the API 824 over a network. While FIG. 8B illustrates a single API-calling component 830 interacting with the API 824, it should be understood that other API-calling components, which may be written in different languages (or the same language) than the API-calling component 826, may use the API 824.

The API-implementing component 822, the API 824, and the API-calling component 826 may be stored in a machine-readable medium, which includes any mechanism for storing information in a form readable by a machine (e.g., a computer or other data processing system). For example, a machine-readable medium includes magnetic disks, optical disks, random access memory; read only memory, flash memory devices, etc.

In FIG. 8C (“Software Stack” 830), an exemplary embodiment, applications can make calls to Service A 832 or Service B 834 using several Service APIs (Service API A and Service API B) and to Operating System (OS) 836 using several OS APIs. Service A 832 and service B 834 can make calls to OS 836 using several OS APIs.

Note that the Service B 834 has two APIs, one of which (Service B API A 838) receives calls from and returns values to Application A 840 and the other (Service B API B 842) receives calls from and returns values to Application B 844. Service A 832 (which can be, for example, a software library) makes calls to and receives returned values from OS API A 846, and Service B 834 (which can be, for example, a software library) makes calls to and receives returned values from both OS API A 846 and OS API B 848. Application B 844 makes calls to and receives returned values from OS API B 848.

### Exemplary Mobile Device Architecture

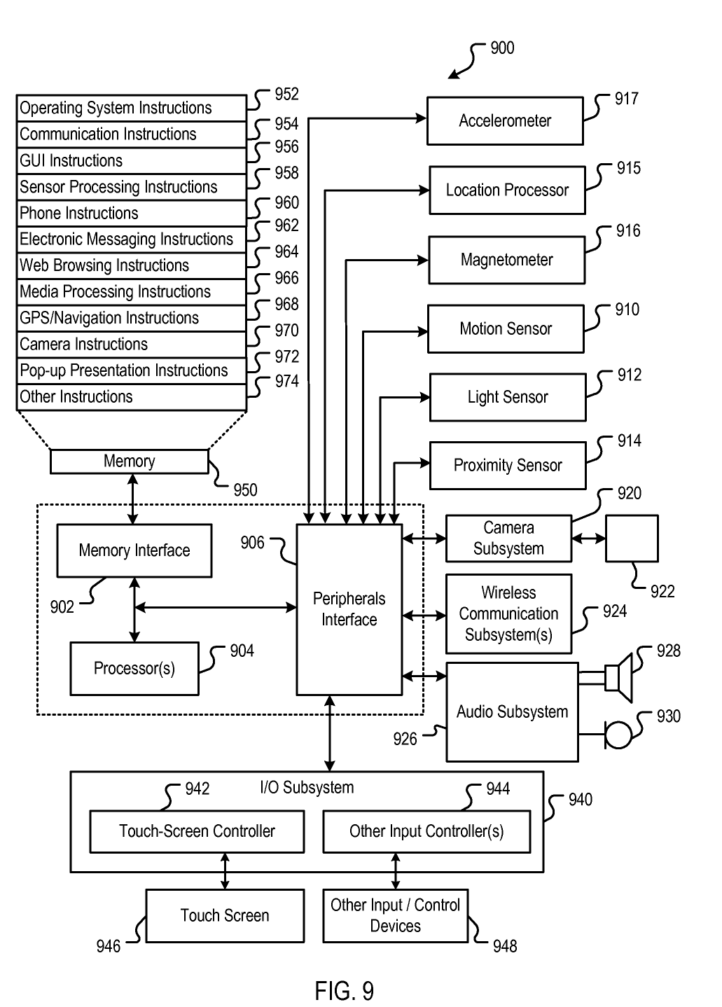

FIG. 9 is a block diagram of exemplary hardware architecture for a device implementing the pop-control presentation processes and interfaces described in reference to FIGS. 1-8. The device can include memory interface 902, one or more data processors, image processors and/or processors 904, and peripherals interface 906. Memory interface 902, one or more processors 904 and/or peripherals interface 906 can be separate components or can be integrated in one or more integrated circuits. The various components in the device, for example, can be coupled by one or more communication buses or signal lines.

Sensors, devices, and subsystems can be coupled to peripherals interface 906 to facilitate multiple functionalities. For example, motion sensor 910, light sensor 912, and proximity sensor 914 can be coupled to peripherals interface 906 to facilitate orientation, lighting, and proximity functions of the mobile device. Location processor 915 (e.g., GPS receiver) can be connected to peripherals interface 906 to provide geopositioning. Electronic magnetometer 916 (e.g., an integrated circuit chip) can also be connected to peripherals interface 906 to provide data that can be used to determine the direction of magnetic North. Thus, electronic magnetometer 916 can be used as an electronic compass. Accelerometer 917 can also be connected to peripherals interface 906 to provide data that can be used to determine change of speed and direction of movement of the mobile device.

Camera subsystem 920 and an optical sensor 922, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 924, which can include radio frequency receivers and transmitters and/or optical (e.g., infrared) receivers and transmitters. The specific design and implementation of the communication subsystem 924 can depend on the communication network(s) over which a mobile device is intended to operate. For example, a mobile device can include communication subsystems 924 designed to operate over a GSM network, a GPRS network, an EDGE network, a Wi-Fi or WiMax network, and a Bluetooth network. In particular, the wireless communication subsystems 924 can include hosting protocols such that the mobile device can be configured as a base station for other wireless devices.

Audio subsystem 926 can be coupled to a speaker 928 and a microphone 930 to facilitate voice-enabled functions, such as voice recognition, voice replication, digital recording, and telephony functions.

I/O subsystem 940 can include touch screen controller 942 and/or other input controller(s) 944. Touch-screen controller 942 can be coupled to a touch screen 946 or pad. Touch screen 946 and touch screen controller 942 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 946.

Other input controller(s) 944 can be coupled to other input/control devices 948, such as one or more buttons, rocker switches, thumb-wheel, infrared port, USB port, and/or a pointer device such as a stylus. The one or more buttons (not shown) can include an up/down button for volume control of speaker 928 and/or microphone 930.

In one implementation, a pressing of the button for a first duration may disengage a lock of the touch screen 946; and a pressing of the button for a second duration that is longer than the first duration may turn power to the device on or off. The user may be able to customize a functionality of one or more of the buttons. The touch screen 946 can, for example, also be used to implement virtual or soft buttons and/or a keyboard.

In some implementations, the device can present recorded audio and/or video files, such as MP3, AAC, and MPEG files. In some implementations, the device can include the functionality of an MP3 player, such as an iPod™. The device may, therefore, include a pin connector that is compatible with the iPod. Other input/output and control devices can also be used.

Memory interface 902 can be coupled to memory 950. Memory 950 can include high-speed random access memory and/or non-volatile memory, such as one or more magnetic disk storage devices, one or more optical storage devices, and/or flash memory (e.g., NAND, NOR). Memory 950 can store operating system 952, such as Darwin, RTXC, LINUX, UNIX, OS X, WINDOWS, or an embedded operating system such as VxWorks. Operating system 952 may include instructions for handling basic system services and for performing hardware dependent tasks. In some implementations, operating system 952 can include a kernel (e.g., UNIX kernel).

Memory 950 may also store communication instructions 954 to facilitate communicating with one or more additional devices, one or more computers and/or one or more servers. Memory 950 may include graphical user interface instructions 956 to facilitate graphic user interface processing; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes and instructions; and camera instructions 970 to facilitate camera-related processes and functions. The memory 950 may also store other software instructions (not shown), such as security instructions, web video instructions to facilitate web video-related processes and functions, and/or web-shopping instructions to facilitate web shopping-related processes and functions. In some implementations, the media processing instructions 966 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 950. Memory 950 can include instructions for presenting pop-up controls 972. Memory 950 can also include other instructions 974.

Each of the above identified instructions and applications can correspond to a set of instructions for performing one or more functions described above. These instructions need not be implemented as separate software programs, procedures, or modules. Memory 950 can include additional instructions or fewer instructions. Furthermore, various functions of the mobile device may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method performed by one or more computer processors of a device, comprising:
receiving first input instructing presentation of a pop-up control within a display area of the device;
in response to the input, identifying a display object that has current input focus in the display area;
determining a content area of the display object and a location of the display object in the display area; and
causing the pop-up control to be displayed in proximity to the location of the display object while avoiding the content area of the display object.

2. The method of claim 1, wherein determining the content area and the location of the display object further comprises:
determining at least one of the content area and the location of the display object through an accessibility application programming interface (API).

3. The method of claim 1, wherein determining the content area of the display object further comprises:
determining a boundary of the display object; and
designating an area within the boundary as the content area of the display object.

4. The method of claim 1, wherein determining the content area of the display object further comprises:
determining areas within the display object that contain text; and
designating the areas that contain text as the content area of the display object.

5. The method of claim 1, further comprising:
prior to receiving the first input instructing presentation of the pop-up control, receiving second input selecting two or more items displayed in the display area, wherein the first input is received while the two or more items remain selected in the display area; and
wherein determining the content area of the display object further comprises:
identifying a combination of the selected two or more items as the display object that has the current input focus;
determining a combined area occupied by the selected two or more items; and
designating the combined area as the content area of the display object.

6. The method of the claim 1, wherein the display object is a segment of selected text and the content area of the display object is a polygonal area enclosing the selected text.

7. The method of claim 1, wherein the display object is a user interface element and the content area of the user interface element is a polygonal area enclosing a textual portion of the user interface element.

8. The method of claim 1, wherein the display object is a user interface element and the content area of the user interface element is a polygonal area enclosing the user interface element.

9. The method of claim 1, wherein the display object is a selectable object in the display area and the content area of the display object is a polygonal area enclosing the selectable object.

10. The method of claim 1, wherein the pop-up control is a pop-up menu.

11. The method of claim 10, wherein the pop-up menu is an application-level menu for an application window containing the display object.

12. The method of claim 10, wherein the pop-up menu is a contextual menu that includes a partial subset of items from an application-level menu, and wherein the partial subset of items are frequently used items applicable to the display object that has the current input focus.

13. The method of claim 10, wherein the pop-up menu contains a menu hierarchy of a first menu and a toggle option associated with an alternative menu, and selection of the toggle option causes the pop-up menu to contain a menu hierarchy of the alternative menu in place of the menu hierarchy of the first menu.

14. The method of claim 13, wherein each of the first menu and the alternative menu is a respective one of an application-level menu and a contextual menu, wherein the contextual menu includes a partial subset of items from the application-level menu and the partial subset of items are frequently used items applicable to the display object encompassing the location of input focus.

15. The method of claim 10, wherein the pop-up menu contains a menu hierarchy of an application-level menu associated with an active application in a desktop environment, the pop-up menu further includes an option associated with a desktop-level menu of the desktop environment, and selection of the option causes the pop-up menu to present menu items from the desktop-level menu.

16. The method of claim 1, wherein the display area is on one of multiple displays associated with the device.

17. The method of claim 1, wherein the display area is a region of a desktop environment that is visually enhanced through an accessibility enhancement program.

18. A computer-implemented method performed by one or more processors of a device, comprising:
receiving an input instructing presentation of a pop-up menu in a display area;
in response to the input, determining a location of input focus in the desktop environment, the location of input focus being different from a current pointer location of a pointing device in the desktop environment; and
causing the pop-up menu to be presented at a location in proximity to the location of input focus in the desktop environment, wherein the menu includes a menu hierarchy of an active application-level menu bar in the desktop environment.

19. A system, comprising:
one or more processors;
a computer-readable medium coupled to the one or more processors and storing instructions, which, when executed by the one or more processors, causes the one or more processors to perform operations, comprising:
receiving first input instructing presentation of a pop-up control within a display area of the device;
in response to the input, identifying a display object that has current input focus in the display area;
determining a content area of the display object and a location of the display object in the display area; and
causing the pop-up control to be displayed in proximity to the location of the display object while avoiding the content area of the display object.

20. A computer-readable medium coupled to the one or more processors and storing instructions, which, when executed by the one or more processors, causes the one or more processors to perform operations, comprising:
receiving first input instructing presentation of a pop-up control within a display area of the device;
in response to the input, identifying a display object that has current input focus in the display area;
determining a content area of the display object and a location of the display object in the display area; and
causing the pop-up control to be displayed in proximity to the location of the display object while avoiding the content area of the display object.
